(19) United States
(12) Patent Application Publication
(10) Pub. No.: US 2015/0021086 A1
(43) Pub. Date: Jan. 22, 2015

(54) METHODS FOR DULLING METALLIC SURFACES AND RELATED PRODUCTS

(71) Applicant: San Diego Gas & Electric Company, San Diego, CA (US)

(72) Inventor: Denis Scott Sanford, San Diego, CA (US)

(73) Assignee: San Diego Gas & Electric Company, San Diego, CA (US)

(21) Appl. No.: 14/336,301

(22) Filed: Jul. 21, 2014

Related U.S. Application Data
(60) Provisional application No. 61/856,533, filed on Jul. 19, 2013.

(51) Int. Cl. E04H 12/08; H02G 7/06

(52) U.S. Cl. CPC E04H 12/08; H02G 7/06
USPC 174/45 R; 134/41; 29/423

(57) ABSTRACT

Various dulling processes for dulling metallic surfaces are disclosed to produce or render galvanized metallic surfaces less shiny. Particular embodiments of dulling galvanized metallic surfaces, such as galvanized steel, iron, and aluminum surfaces, and processes are disclosed to treat galvanized objects for color variation or enhancement while still maintaining protection provided by the galvanized layer. The present disclosure is also directed to apparatus, product and system having dulled surfaces formed by the disclosed dulling processes.

### FIELD OF ART

The present disclosure relates to dulling processes for dulling metallic surfaces, such as to render metallic surfaces less shiny, and to metallic structures having the process applied thereto. Particular discussions extend to dulling galvanized metallic surfaces, such as galvanized steel, iron, and aluminum surfaces, to treat for color variation or enhancement while still maintaining protection of the base metal by the galvanized layer. The present disclosure is also directed to apparatus, product and system having dulled surfaces formed by the disclosed dulling processes.

### BACKGROUND

Various metallic surfaces are galvanized to provide protection from the environment and from wear and tear. Galvanization is well known and involves applying a protective coating primarily consisting of zinc to a metallic surface so that the zinc-based layer protects the subjacent metallic surface or structure. The zinc-based layer serves as a sacrificial anode to cathodically protect exposed steel and metal. This means that even if the coating is scratched or abraded, the exposed surfaces will still be protected from corrosion by the remaining zinc, which is an advantage over paint, enamel, powder coating and other methods. Galvanizing is also favored as a means of protective coating because of its low cost, ease of application and comparatively long maintenance-free service life.

Galvanization can be formed by electrochemical, electrode position or electroplating, and hot-dip galvanization. Electroplating is less expensive to apply but produces a relatively thin protective and shiny coating compared to hot-dip galvanization. Hot-dip zinc-based coating tends to leave a matte gray finish while electroplating tends to leave a brightly reflective finish. As the zinc layer can wear, the thickness of the galvanized layer is a variable that can be controlled to increase the time between maintenance. A 2-mil (thousandths) galvanized layer can protect and defer maintenance to the base layer for about 30 to 60 years depending on the location and service of the coated product, such as being in a temperate marine location, rural, industrial, or tropical marine location. A thicker zinc-based coat can provide even longer maintenance free service. For certain structures, such as transmission towers, distribution towers, light poles, and street signs, maintenance free service life is crucial and provides a tremendous cost saving to the servicing entities.

Although galvanized metallic is generally preferred from an environmental and wear and tear perspective, the finished color coat is not uniformly favored. Among other things, it is limited to gray with some variation in shininess. Thus, for decorative purposes, visual effects, environmentalists, and visual acuity when set against the environment or other background, the limited color produced by the galvanization process may not yield the ideal outcome for the discerning taste or job specification. In other instances, zoning, rules and regulations may require a different color than the shiny shades of gray.

### SUMMARY

Aspects of the present disclosure include a process for dulling a galvanized metal object. As disclosed, the process includes the steps of obtaining a non-passivated galvanized metal object in at least two attachable sections including a first section and a second section. In some examples, the galvanized metal object is passivated before undergoing the treatment steps. The treatment steps include cleaning the galvanized metal object in a first bath comprising alkali salts, surfactants, water and an acidic accelerator; rinsing the galvanized metal object in a water bath; and soaking the galvanized metal object in a dulling bath comprising zinc phosphate and acid for at least 45 seconds to produce a treated galvanized metal object. To determine whether the dulling is acceptable, the process can further include the step of measuring the treated galvanized metal object with a spectrophotometer to obtain a value, such as a reflection value, a desired color value, color data, color difference data, color plot, spectral data, special difference data, special plot, or spectral difference plot, and wherein the value is at least 8-10% less than the same value of an untreated shiny galvanized surface. In one example, the value is a desired color value of 74 or less where a new shiny galvanized surface has a value of between about 75-85.

The process wherein the galvanized metal object is soaked in the dulling bath for at least 45 seconds. The soak time can vary depending on the acid concentration of the dulling bath. The higher the concentration, the shorter is the soak time. Conversely, the weaker is the concentration, the longer is the soak time. In some examples, soak time can vary between two different objects to be dulled for the same acid concentration where the two objects have different surface areas or thicknesses. An object to be dulled with a greater surface can take surprisingly less time to soak than an object with a smaller surface area for the same bath to achieve the same color value or dull value. Said differently, a smaller object can take longer time to dull than a larger object.

In some examples, the -passivated galvanized metal object is a standalone single object, such as a bracket or a complete support structure.

The process wherein the dulling bath comprises a mixture comprising zinc nitrate, zinc dihydrogen phosphate, magnesium nitrate, phosphoric acid, zinc fluoborate, and nickel nitrate.

The process wherein the dulling bath comprises a mixture comprising zinc fluoride, zinc dihydrogen phosphate, zinc nitrate, phosphoric acid, and nickel fluoride.

The process wherein the treated galvanized metal object is a component of a transmission tower or a distribution tower.

The process wherein the treated galvanized metal object is re-soaked in the dulling bath for at least 60 additional seconds.

The process wherein the treated galvanized metal object is treated with a corrosion inhibitor after removal from the dulling bath.

The process wherein the non-passivated galvanized metal object is a nut, a bolt, an art work, a metal chain link fence, a guard rail, a temporary road sign, a street sign, a freeway sign, or combinations thereof.

A further feature of the present disclosure is a tower for carrying electrical conductors. In some examples, the tower includes an upstanding body having at least one support arm extending laterally of the body. The body and the at least one support arm are galvanized with a zinc-based material. The body and the at least one support arm being dulled from the original shade produced by the galvanized process and wherein the dulled shade has a spectrophotometer reading of 56 or less produced by a dulling process. In some examples, the dulling process comprises the steps of cleaning the body and the at least one support arm in a first bath comprising alkali salts, surfactants, water and an acidic accelerator; and soaking the body and the at least one support arm in a dulling bath comprising zinc phosphate and acid for about 120 seconds to about 720 seconds.

The tower wherein the body is a lattice structure.

The tower wherein the body is a hollow metal pole.

The tower wherein the at least one support arm is bolted to the body.

The tower further comprising bolting a second support arm above the at least one support aim relative to the ground.

The tower wherein the reading is less than 45.

A still further feature of the present disclosure is a method for blending a metal structure to the environment, such as to the rolling hills of a countryside, of a park, of a private property, or of a public property, etc. so that the dulled metal structure is less conspicuous against the backdrop than un-treated galvanized metal objects, such as galvanized transmission or distribution towers that have not been dulled. The method can comprise the steps of obtaining a galvanized metal object; cleaning the galvanized metal object in a first bath comprising alkali salts, surfactants, water and an acidic accelerator; soaking the galvanized metal object in a dulling bath comprising zinc phosphate and acid for at least 120 seconds to produce a treated galvanized metal object; and installing the treated galvanized metal object in an exposed environment; and wherein the treated galvanized metal object has a spectrophotometer value of 56 or less.

The method wherein the treated galvanized metal object is a transmission tower or a distribution tower carrying a plurality of conductors.

The method wherein treated galvanized metal object is soaked in the dulling bath a second time.

The method further comprising the step of applying a corrosion inhibitor to the treated galvanized metal object.

The method wherein the galvanized metal object is non-passivated.

### BRIEF DESCRIPTION OF THE DRAWINGS

These and other features and advantages of the present device, system, and method will become appreciated as the same becomes better understood with reference to the specification, claims and appended drawings wherein:

FIG. 1 is a depiction of a transmission tower that has been zinc-based coated or galvanized and then subsequently dulled by one or more processes of the present disclosure.

FIG. 2 is a depiction of a street light that has been zinc-based coated or galvanized and then subsequently dulled by one or more processes of the present disclosure.

FIGS. 3 -5 show fasteners and fence materials that have been zinc-based coated or galvanized and then subsequently dulled by one or more processes of the present disclosure.

FIGS. 6-10 show different types of street, freeway signs and lights that have been zinc-based coated or galvanized and then subsequently dulled by one or more processes of the present disclosure.

FIGS. 11-12 show different art works made from a metallic material that have been zinc-based coated or galvanized and then subsequently dulled by one or more processes of the present disclosure.

FIG. 13 shows an exemplary treating process provided in accordance with the present disclosure.

FIG. 14 shows a process flow diagram depicting different steps for dulling a zinc-based coated or galvanized metallic object.

### DETAILED DESCRIPTION

The detailed description set forth below in connection with the appended drawings is intended as a description of the presently preferred embodiments of dulling processes and products and components produced thereby in accordance with aspects of the present devices, systems, and methods and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

Various ornamental and architectural metallic structures are utilized in everyday applications. Because they are metallic, they will oxidize and will degrade over time. Thus, aspects of the present disclosure are directed to protective coatings for shielding the base metal structure from unwanted rapid degradation. Accordingly, all devices, apparatuses, and systems set forth herein include a metallic base structure that has been galvanized, such as being coated with a predominately zinc layer, such as a zinc-based layer, by any known means including by electrochemical, electro deposition or electroplating, and hot-dip galvanization. Additionally, the galvanized base structure further includes at least a portion or section thereof that has been post-galvanized treated for color variation or enhancement by a dulling process, as further discussed below. In some examples, the entire base structure is post-galvanized treated for color variation or enhancement by the disclosed dulling process.

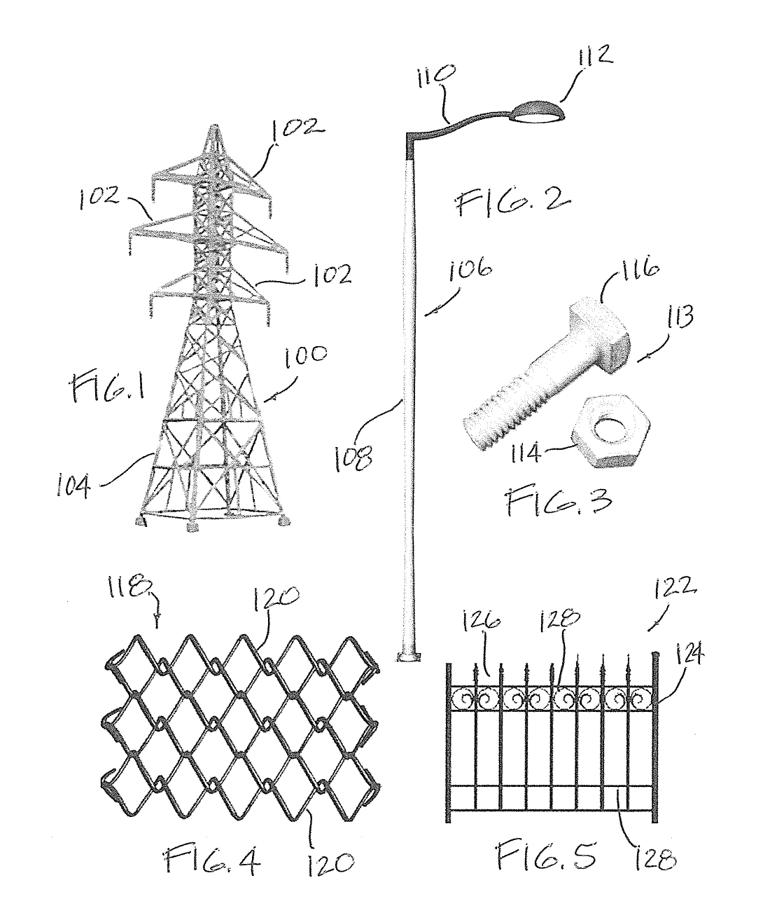

With reference now to FIG. 1, an electrical transmission tower 100 is shown, which includes three tiers of power line arms 102 projecting above a lattice base assembly 104. The tower therefore may be understood to include a central body having at least one support arm attached thereto, such as by welding, bolting or fastening, or combinations thereof. The tower 100 may also be understood to be useable as a distribution tower. The tower 100 may be made from steel or aluminum or a combination thereof. The tower 100 may also be fabricated in sections and assembled on site, or flown from an assembly yard to a final tower site by using air crane and the like. The tower 100 is preferably first galvanized and then post-galvanized treated for color variation or enhancement in accordance to a dulling process of the present disclosure, either as a whole or in sections. In some examples, metal poles, such as steel poles, are used instead of lattice structures with each pole provided with power line arms. When used, the steel poles are first galvanized and then post-galvanized treated for color variation or enhancement in accordance to the dulling process of the present disclosure.

FIG. 2 shows a street or freeway light 106 comprising a metallic post 108 and an overhang arm 110 having a lamp housing 112 with a lamp or light bulb located therein. The street or freeway light 106 is preferably first galvanized and then post-galvanized treated for color variation or enhancement in accordance to a dulling process of the present disclosure, either as a whole or in sections.

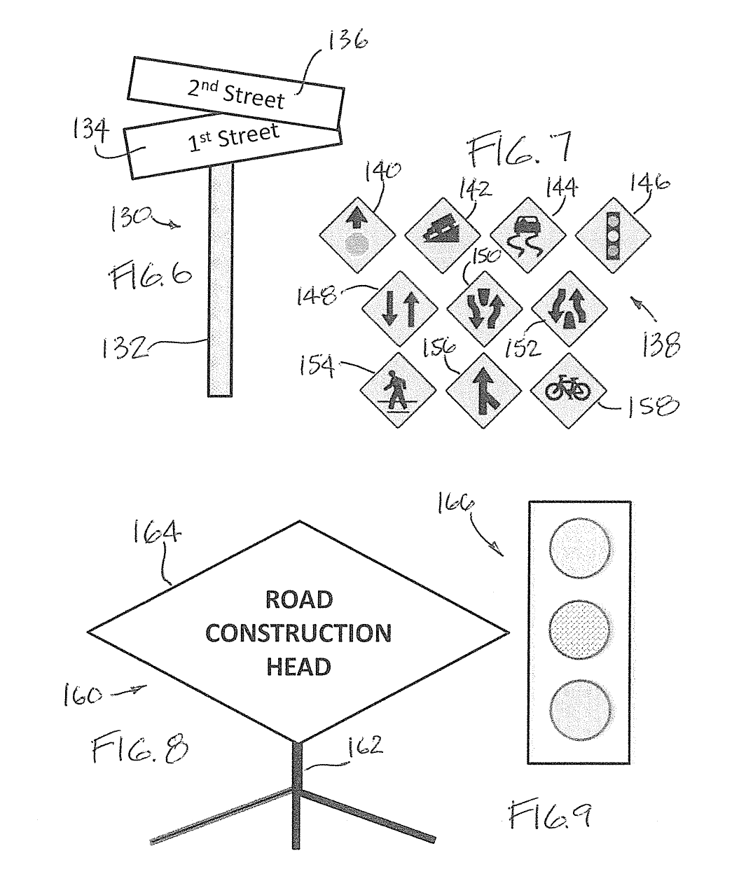

FIG. 3 shows a fastener 113 comprising a nut 114 and a bolt 116 that have been galvanized and then post-galvanized treated for color variation or enhancement in accordance to a dulling process of the present disclosure. In other examples, different types of fasteners are used, including wing nuts, anchor bolts, screws, rivets, button heads, Allen head bolts, eye bolts, eye lugs, metal chains, cotter pins, hair pin cotters, and washers, including a flat washers, lock washers, bellevue washers, and the like. Fasteners are formed from different grades of steel and may be zinc coated in bulk and post-galvanized treated in bulk, as further discussed below.

FIG. 4 shows a metal chain-link fence section 118 comprising a plurality of intertwined wires 120. The fence section 118 is preferably first galvanized and then post-galvanized treated for color variation or enhancement in accordance to a dulling process of the present disclosure, typically in rolled sections.

FIG. 5 shows a wrought iron fence section 122 comprising two end poles 124 and several intermediate poles 126 having decorative upper ends and decorative horizontal support frames 128. In other examples, the number of intermediate poles and the type of decorative ends and horizontal support frames can vary depending on the likes and tastes of the individual consumer. The wrought iron fence section 122 is typically designed and sized in various sections to enclose a designated area. The various sections can be bolted or welded together in place or on-site. The wrought iron fence section 122 is preferably first galvanized and then post-galvanized treated for color variation or enhancement in accordance to a dulling process of the present disclosure, either as a whole or in sections.

FIG. 6 shows a street sign 130, which comprises a metal pole 132, such as a steel pole, supporting a first street sign 134 and a second street sign 136, typically found at 4-way intersections. The street signs 134, 136 are typically constructed with a reflective coat to reflect light beams from on-coming traffic. The pole 132 is typically made from a metal material, such as a steel pole, and zinc-coated for long term protection. In one example, the pole 132 is post-galvanized treated for color variation or enhancement in accordance to a dulling process of the present disclosure, as further discussed below.

FIG. 7 shows a plurality of different warning signs or traffic signs 138 that may each be supported on a steel post, such as the post 132 of FIG. 5. Shown are a stop ahead sign 140, a downhill slope or grade sign 142, a slippery when wet sign 144, a street light ahead sign 146, a two way traffic sign 148, a divided highway sign 150, a divided highway end sign 152, a pedestrian crossing sign 154, a merging traffic sign 156, and a bike crossing sign 158. The posts for traffic signs having one of the above-noted signs, as well as other traffic and warning signs, may be zinc coated and post-galvanized treated for color variation or enhancement in accordance to a dulling process of the present disclosure, as further discussed below. Preferably only the posts holding up the signs, as well as any fittings and fasteners, are coated with a zinc-based layer and color treated. The signs themselves are typically coated with a reflective layer or film.

FIG. 8 shows a temporary traffic sign 160 comprising a support stand 162 and a traffic sign 164, which may have any number of messages for alerting drivers and pedestrians. The support stand 162 is typically made from steel angles or brackets, which can be galvanized for protection against rust, wear and tear. In one example, the support stand 162 is post-galvanized treated for color variation or enhancement in accordance to a dulling process of the present disclosure, as further discussed below.

FIG. 9 shows a traffic light 166. The light 166 is typically mounted on a vertical metal post or on a vertical post with an arm overhanging to a side to enable positioning of the light 166 to the arm and directly over the street below. The post is somewhat similar to the post 108 shown in FIG. 2. Preferably the post holding up the light 166 or holding the arm that holds the light 166, as well as any fittings and fasteners, are zinc coated and color treated.

FIG. 10 shows a freeway sign structure 168, which typically comprises a frame structure 170 holding up a freeway sign 172. The sign structure 168 may be hung, via the frame structure 170, directly to an overpass structure or to an overhang attached to a post. The frame structure 170, the overhang and post, as well as any fittings or brackets, for holding up the freeway sign 168 are zinc-coated for long term protection. In one example, the frame structure 170, including the post with overhang, fittings and brackets, if any, is post-galvanized treated for color variation or enhancement in accordance to a dulling process of the present disclosure, as further discussed below.

FIG. 11 is a decorative metal wall art 174 comprising two generally rectangular art works 176 located side-by-side. The rectangular art work 176 is formed by welding various small metallic components 178 together to create a pattern or abstract design. The wall art 174 may be mounted interiorly or exteriorly. The two rectangular art works 176 are preferably first galvanized and then post-galvanized treated for color variation or enhancement, either together or separately, as further discussed below. In other examples, other decorative art pieces are first galvanized and then post-galvanized treated for color variation or enhancement. For example, the decorative art can be a metal flower pot, a metal yard art piece, an abstract metal art piece in a common external business area, a building signage, an exterior door sign or art work; a balcony guard rail, fanciful metal art vehicle, such as a bicycle, motorcycle, or car, etc. Typically, decorative structures are either painted or left as they are following their formation and allowed to rust. As an alternative, the decorative structures are first zinc-based coated or galvanized to provide long term protection against rust and wear and tear and then subsequently treated for color variation or enhancement, to like less like galvanized metal.

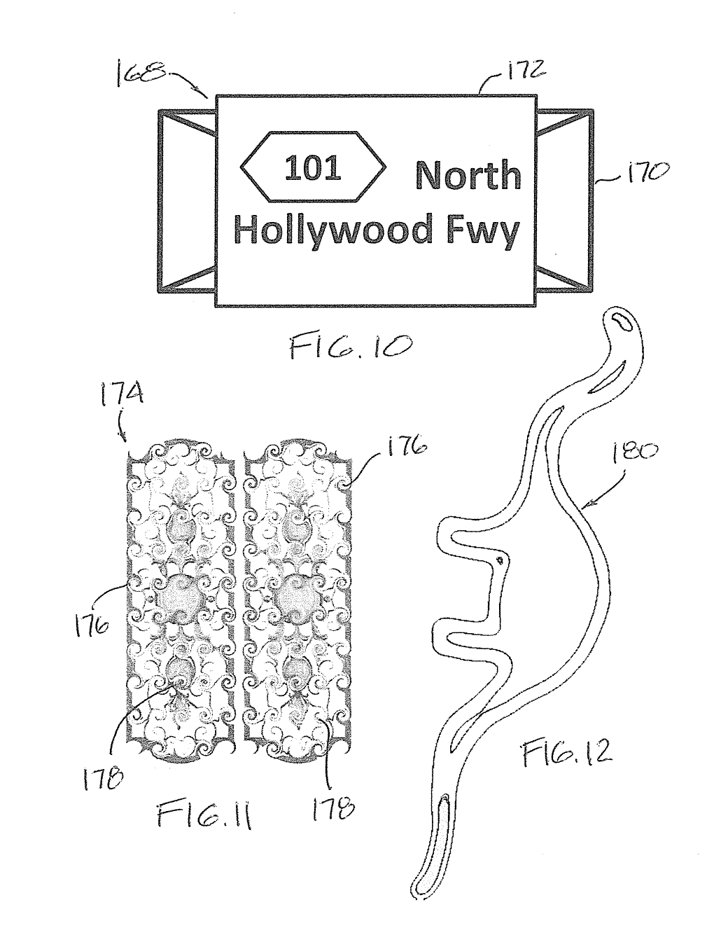

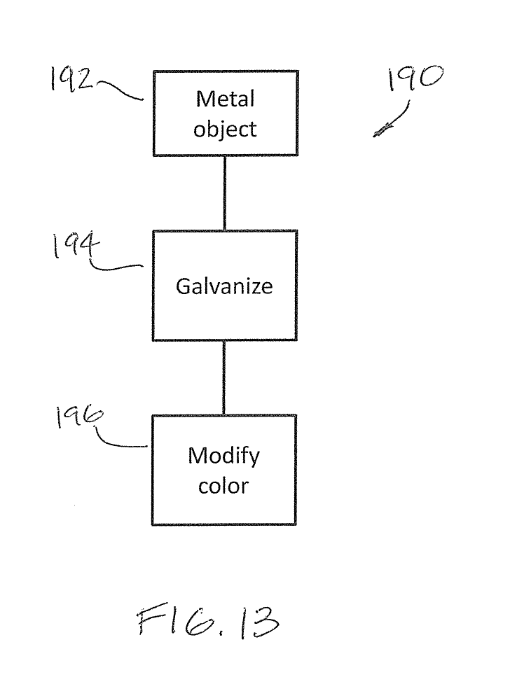

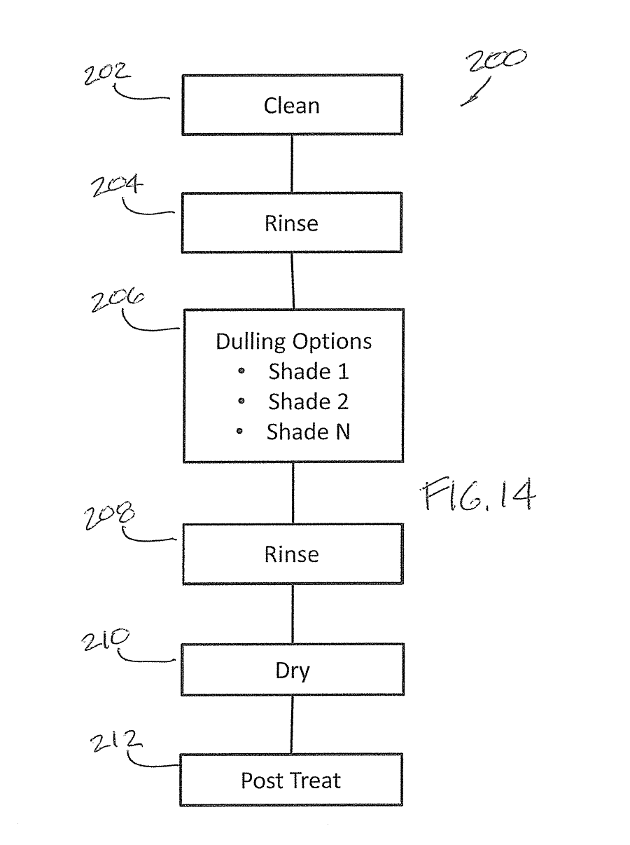

FIG. 12 is another decorative art piece 180 provided in accordance with aspects of the present invention, which include devices, systems, and methods. As shown, a dinosaur art work is made from a combination of metal wires or rods, sheets, brackets and fasteners. The dinosaur art work is then zinc coated and then subsequently treated for color variation or enhancement. In other examples, other metallic animal art work pieces are provided, which are zinc coated and then subsequently treated for color variation or enhancement.

With reference now to FIG. 13, a process or method for treating a metallic object, such as one of the disclosed objects in FIGS. 1-12 and discussed elsewhere herein, is shown, which is generally designated 190. In an example, the metal object may come in all possible sizes and shapes, including sheets, strips, tubes, wires, and their combinations. At step 192, the metal object, which can be made from steel, iron, or aluminum, is obtained and then galvanized at step 194. The galvanized step may be performed using any number of known methods, including by electrochemical, electro deposition or electroplating, and hot-dip galvanization. Depending on the application and cost, one galvanized method may be preferable over the other. At step 196, the galvanized metal object is subjected to a number of steps that include alkaline washing, degreasing, and subjecting to an acetic blend of zinc, nickel, phosphate, nitrate, and fluoride to dull the shiny gray galvanized surface. The post-galvanized treated object has an altered appearance that may be desirable in various applications either for aesthetic appeal, to meet regulations, or to meet job requirements. Thus, an aspect of the present disclosure is understood to include a method for blending a metal structure to the environment by obtaining a galvanized structure, either passivated or non-passivated, and then dulling the structure before mounting or installing the dulled galvanized structure in an exposed environment, such as near a park, in a countryside, on public land, on government land, etc.

Experiments have shown that the resultant colors for the different treated samples, depending on the concentration, time and chemical blends used, have the appearance of dark gray to medium gray with a flat or matte appearance and possibly with a hint or touch of other colors. More or less of colors other than gray and reducing shininess of a galvanized surface are possible by altering the chemical blends and time of treatment as well as the number of cycles to treat the galvanized object.

To measure the degree of color and implement quality control during the dulling process, a device for determining the quantitative measurement of the reflection or transmission properties of a material as a function of wavelength may be utilized, such as a spectrophotometer. In one example, a Hunters Lab MiniScan EZ spectrophotometer is used. A typical untreated galvanized shinny coat has a range of 75-85 on a scale of 0-100 on the spectrophotometer. After treating the galvanized metal with the processes of the present disclosure, a reading as low as 11 on the spectrophotometer was achievable. By varying the compositions and soak time, different values are also obtainable. Based on these results, three different dulling categories as measured with a spectrophotometer can be established as follows:

| | |
|---|---|
| Dark gray | 0-33 |
| Medium gray | 34-55 |
| Light gray | Above 56 |
| Normal galvanized object | 75-85 |

As further discussed below, the present process is able to dull objects to achieve a zinc coat color that is less than 33 for a dark dull and a score of about 45-55 for a medium dull, depending on the process or processes used to treat the metal. Thus, an aspect of the present disclosure is understood to involve a cleaning process, a chemical treating process, and an electronic reading process to verify the dullness of the galvanized metallic object.

With reference now to FIG. 14, a process or method for treating a galvanized metal object is shown, which is designated 200. In one example, the process involves obtaining a non passivated galvanized metal object, i.e., a galvanized steel that has no passivation treatment, such as one of the disclosed objects in FIGS. 1-12 and discussed elsewhere herein. In other examples, passivated galvanized metal objects are used. At 202, the process involves cleaning the object. The cleaning step 202 prepares the galvanized metal object for further treating and removes dirt, oil and grease, if any, from the top coat. In one example, the cleaning process involves placing the galvanized object in a tank comprising a first bath or first solution, which in one embodiment comprises a 1 gram/liter concentration of aqueous solution of alkali salts and surfactants and water in the following mixture:
25-50% alkyl alkoxylate
10-20% alkyl alkoxylate, mod.
1-2.5% sodium octanoate

The bath should be maintained at about 60 degrees C., ±10 degrees C., and soaked for about 1 minute up to about 3-5 minutes. However, the soak time to clean the galvanized metal object can be much longer, such as for over 10 minutes, if desired. In another example, the concentration can range from 0.1 to 20 g/L and the bath time is for 45 sections up to about 20 minutes. Cleaning time can depend on the thickness and size of the members to be treated. A typical jig having a number of objects, such as an apparatus for hanging or holding the galvanized objects to be treated, for the electrical distribution or transmission tower of FIG. 1 can take as little as about 1 minute. Objects that have been hot-dip galvanized can also take less time than shinier electroplated small components, which can take 3-5 minutes to clean.

Optionally, an accelerator may be added to the aqueous solution of alkali salts and surfactants to reduce processing time and provide wider, more flexible operating parameters. In an embodiment, an acidic accelerator, such as hydrofluoric acid or sulfuric acid, is used as a separate acidic cleaning step that may occur before or after the alkaline cleaning step. The accelerator useable herein can include hydrofluoric acid in a concentration of 10%≦X≦25% mixed at a concentration of 15 g/L with the aqueous solution of alkali salts and surfactants in situ to form the first bath comprising, consisting, or consisting essentially of alkali salts, surfactants, accelerator, and water. A range of 10 g/L to 20 g/L of the accelerator can be effective in enhancing the surface cleaning of the galvanized object. The first bath may contain at least one or at least two components selected from the group of hydrofluoric acid, sulfuric acid, nitric acid, phosphoric acid, sulfonic acid, citric acid, gluconic acid, a carboxylic acid, a bifluoride, caustic soda, any of their derivatives, any surfactants and any additives. In one example, a corrosion inhibitor is added to prevent acid attack and pitting. Exemplary inhibitors include Gardobond®-Additive H, NALCO 39M corrosion inhibitor and the HALOX® family of corrosion inhibitors, which include calcium phosphate based and barium phosphosilicate-based corrosion inhibitor.

In experiments conducted, special tanks compatible with the process chemicals were used such as a polypropylene homopolymer (PPH) tank to hold the first and second baths. Optionally, concrete or stainless steel tanks with internal coatings that are compatible to withstand the alkali salt solutions may be used. To have sufficient capacity to treat transmission tower in large sections, such as the tower shown in FIG. 1, the tanks were provided with the following size: 5.35 ft×29.19 ft×8.2 ft, W×L×H. An overhead rigging system may be used, such as a hoist, to raise and lower the metal objects to be treated. In other examples, a basket may be used with the hoist to hold a plurality of small metal objects to be treated. Known piping, filling, filtering, heating, mixing, and blending tools and equipment may be connected to the cleaning tank and to other tanks discussed elsewhere herein to automate or to semi-automate the cleaning and dulling processes.

Dulling samples obtained with cleaning solutions having the accelerator show a more uniform, i.e., more evenly distributed, dull surface color throughout the treated galvanized object with only small to very little blotches while samples treated without the accelerator show dulling with spotted or coarse shades or blotches having varying dull surface appearance. However, in general, the process with cleaning solutions with and without the accelerator produces a galvanized surface having an appearance that is noticeably less dull than the original gray surface before the process. As further discussed below, reflectivity, which is a measure of shininess, from an original zinc coat of 75-85 can be reduced to a light gray color reflectivity of 55 and above but less than about 75 and medium gray color reflectivity of 33-55. A dark gray color reflectivity of less than 33 can also be achieved using the process of the present disclosure. The different dulling ranges can be achieved by selecting different chemical solutions and varying the acid concentration when soaking, with varying soak time depending on the acid concentration, the cleaned product under different variable conditions, as further discussed below.

After the galvanized metal object is washed as described at step 202, it is removed from the first bath and allowed to drip and dry. The galvanized metal object is then placed into a second bath in a second tank at step 204 to rinse. In one example, the second bath is kept at about 20 degrees C. to about 25 degrees C., or at roughly ambient temperature, for about 45 seconds to about 3 minutes and is primarily tap water, although treated water and deionized water are contemplated. Longer soak time is also permitted but the benefit for the increased time is negligible. The rinsing step with water reduces chemical carry-over of processing chemicals into the next treatment stage.

In experiments conducted, a coated polypropylene homopolymer (PPH) tank was used to hold the second bath, similar to the tank for the first bath. To have sufficient capacity to treat transmission tower sections, such as the tower shown in FIG. 1, the PPH tank was provided with the following size: 5.35 ft×29.19 ft×8.2 ft, W×L×H. A stainless steel (SS) tank, such as 316 grade SS, and a coated concrete tank, which can be coated with plaster or a resin, are also contemplated.

The rinsed galvanized metal object is allowed to air dry before proceeding to step 206. In an alternative embodiment, forced air or circulated air may be used to facilitate drying before proceeding to step 206. In still yet another alternative embodiment, the rinsed galvanized metal object can be moved directly into a third tank for treatment in a third bath at step 206. The time it takes to move the object from the second tank to the third tank is sufficient to dry the cleaned object and proceed to step 206.

Dulling at step 206 includes a distinct step or a combination of steps, as further discussed below. To dull the galvanized metallic object to a light to medium dull reflectivity, a third bath or a dulling bath is prepared in a third tank using an immersion applied zinc phosphate conversion coating material and sulfuric acid (H2SO4). The zinc phosphate mixture is a blend of the following by weight percentage:
10-30% zinc nitrate
5-10% zinc dihydrogen phosphate
5-10% magnesium nitrate
1-5% phosphoric acid
1-5% zinc fluoborate
1-5% nickel nitrate

The zinc phosphate mixture is blended in a 9-15% by volume with water and 0.5-10% sulfuric acid. The third bath should be kept at about 60 degrees C., ±10 degrees. The soak time for the galvanized metal object can be about 45 seconds to about 12 minutes for a light dull to a medium dull. Prior to sampling, the tank should be filled with water to a desired service level and equipped with a mixer to thoroughly mix the zinc phosphate solution. The bath concentration may be controlled by determining the phosphate points and iron points. For each phosphate point consumed, 1-2% by volume of the zinc phosphate mixture and water should be replenished in discrete intervals so that not more than about 2 phosphate points are replenished at a time. Preferably, continuous metering should be provided to ensure a steady concentration.

During production, a supplemental blend of GARDOBOND Z 3100 EU 8-12% by volume and H2SO4 at a concentration of 0.5 to 3% by volume should be added to the third bath and maintained at 60 degrees C., ±10 degrees.

Because the process at step 206 involves using an acid bath with a pH level of less than 7, a coated polypropylene homopolymer (PPH) tank was used during experiments to hold the third bath. To have sufficient capacity to treat transmission tower sections, such as the tower shown in FIG. 1, the PPH tank was provided with the following size: 5.35 ft×29.19 ft×8.2 ft, W×L×H. However, a metal tank is contemplated. If a metal tank is used, 316 stainless steel, and less preferred 304 SS, tank may be used. Chemical metering pumps, fitting, pipes, heaters and any other device that comes in contact with the third bath should be selected with the acidic condition in mind. A medium dull of about 50 to 55 measured by a spectrophotometer was achievable using the described solutions and steps. If the soak time is reduced to about 45 seconds to about 3 minutes, a light gray of about 58 to 60 is achievable.

Surface profile of a galvanized metal object to be dulled can also vary the soak time. A relatively thick member or large surface area member is surprisingly quicker to dull than something with a relatively lower profile. Thinner parts, such as parts with relatively thinner metal, can take much longer than thicker parts. Thus, in one example, objects with somewhat similar thicknesses are separated from parts with different thicknesses. The parts with similar thicknesses are treated together as they dull at similar dull rates for the same soak time. In one example, 20-30 parts or galvanized objects to be treated may be hung or positioned on a jig, which can be a maneuverable platform for raising and lowering objects into the baths.

Thus, an aspect of the present disclosure is understood to include a method for dulling a metallic object comprising the steps of obtaining non-passivated galvanized metal object; cleaning the metal object with an aqueous cleaning solution of alkali salts, surfactants and water; and soaking the metal object in a zinc phosphate water mixture for about 45 seconds to about 12 minutes to obtain a dullness reading of about 40 to about 60 on a spectrophotometer. The higher the dull value reading, the shorter is the soak time, which also depends on the acid concentration. In some examples, an accelerator is added to the aqueous cleaning solution. The accelerator may be added in a range of 10 g/L to 20 g/L of the aqueous cleaning solution at least one or at least two components selected from the group of hydrofluoric acid, sulfuric acid, nitric acid, phosphoric acid, sulfonic acid, citric acid, gluconic acid, a carboxylic acid, a bifluoride, caustic soda, any of their derivatives, any surfactants and any additives. In a specific example, the bath having the zinc phosphate mixture is made from concrete, stainless steel, or from a polypropylene homopolymer. Less preferred, the metal object is a passivated galvanized metal object.

The soaking step may comprise a bath having a zinc phosphate mixture blended in a 9-15% by volume with water and 0.5-10% sulfuric acid. Preferably, the metal object is rinsed after the cleaning step and before soaking in the zinc phosphate water mixture. In some examples, after the metal object is removed from the bath containing the zinc phosphate water mixture, it is measured with a spectrophotometer to obtain a first dullness value and then re-soaked in the zinc phosphate water mixture for several additional minutes to lower the dullness reading to a lower second dullness value. The additional soaking can range from about 45 seconds to about 10 additional minutes. In specific example, the first dullness value is greater than 56 but below 75 and the second dullness value is below 56 but greater than 34.

In some examples, the metal object comprises several sections of a transmission tower or a distribution tower. The several sections are subsequently shipped to an installation site and installed as a complete transmission tower or distribution tower. In still other examples, the metal object is a tower comprising a metal pole with power line arms attached to the pole.

If a darker dull is desired, with a reflectivity of 33 or less, the third bath at step 206 can be prepared using a different immersion applied zinc phosphate conversion coating material in the following dulling bath blend by weight:
1-5% zinc fluoride
10-20% zinc dihydrogen phosphate
10-20% zinc nitrate
10-20% phosphoric acid
1-5% nickel fluoride

The conversion coating material may be used in a 6 to 12% by volume concentration with water, in a 60 degrees C., ±10 degrees bath with 10% being more preferred. During soaking, the bath is titrated for acid and is adjusted if necessary. Prior to placing the washed galvanized metal object into the third bath for dark dulling, the initial concentration should be on the high end of the operating range. The acid may be adjusted by blending or supplementing with H2SO4 (sulphuric acid) at a concentration of 0.5 to 3% by volume will speed up dulling and provide a darker and deeper dulling appearance. Total acid should be between 20-30 ml, free acid between 1.5-2.5 ml, and total to free acid ratio of 10-14. In some experiments, the third tank is kept at a temperature ranging from 60 to 70 degrees C. and the soak time is 60 seconds to about 5 minutes up to about 10 minutes, depending on the acid concentration. For shinier objects, such as electroplated nuts and bolts, the soak time is closer to 5-10 minutes and possibly even longer. Smaller objects, such as relatively thinner walled materials, can also take longer to soak than larger objects with greater walled thicknesses. Good temperature control should be kept or regulated as too low or unregulated low temperature can prevent the zinc phosphate coating from forming while too high of a temperature can cause poor coating and excessive sludge.

If the galvanized metal object is left in the third bath for too long, such as fifteen minutes and longer, the risk of stripping or dissolving the galvanized outer layer of the metal object increases, which can translate to less mean-time between maintenance fee service. Thus, for a certain bath mixture, the soak time should be appropriate and not unnecessarily prolonged without sacrificing stripping good galvanized layer. Additionally, a corrosion inhibitor may be added to prevent acid attack and pitting. In still other examples, the soaked material is raised and either visually inspected or measured with a spectrophotometer and then placed back into the bath for longer soak time if deemed insufficiently dulled.

Commercially available conductivity/concentration control system and chemical metering pump may be installed to monitor and automatically maintain the concentration of solution using conductivity. In one example, a complete replacement of the first bath, second bath, or third bath or combinations thereof are replaced after every 30 to 50 times that the bath or baths are used. In another example, a fixed time period is established to replace one or more of the baths, such as every 6 to 12 weeks with every 8 weeks or two months being more preferred.

In yet another example, the galvanized metallic layer is first treated in a bath to produce a medium dull color, as described above, and then subsequently subjected to another dulling bath for dulling to a darker color, but for comparatively shorter soak time, such as 30% to 60% less time compared to if the dulling process is for a straight dark dulling, as discussed above. In still another example, the dulled metal object is measured for dullness and replaced back into the medium dulling bath for a longer soak time. In the alternative process with serial soaking in different dulling baths, the dulled galvanized surface can produce a gray color that is substantially and visibly more dull than the original galvanized gray. Preferably, a rinse bath is used in between two serial dulling baths.

After the galvanized metal object is dulled at step 206, it is removed and then rinsed at step 208. In practice, the galvanized metal object can be repositioned back into the second bath for rinsing discussed above with reference to step 204. In an alternative embodiment, a fourth bath in a fourth tank is provided to rinse any residual chemicals from the surface of the dulled galvanized metallic object. The fourth bath may simply consist of water, either tap, treated or deionized water, held at ambient temperature for about 1 minute or more.

At step 210, the object is removed and dried. In one example, a bank of fans is used to circulate air over the surfaces of the dulled galvanized metal object. In a less preferred embodiment, the object is allowed to air dry.

At step 212, the dulled galvanized metal object is inspected, such as by visual inspection or by reading using a spectrophotometer, for dulling consistency. The object can also be spot check under a microscope for pitting, the extent of zinc layer wear or stripped by the process, and dulling consistency. In a specific example, the dulled galvanized metal object is measured with a spectrophotometer and if a reading of 33 or less is not achieved, the metal object is re-soaked in the immersion applied zinc phosphate solution for dark dulling for about 30 seconds to about 5 minutes.

Whether the galvanized layer is acceptable or unaffected by the dulling steps described in steps 202-210, an optional final rust prevention coating step may be performed. In one example, a corrosion inhibitor, Gardorol DW 400 from Chemetall, is sprayed to the surfaces of the treated galvanized metal object. In an alternative example, a petroleum based rust inhibitor, such as ARDROX 3961 from Chemetall, is sprayed onto the surfaces of the treated galvanized metal object. In yet another example, both types of inhibitors are sprayed onto the treated galvanized metal object. In practice, either Gardorol DW 400 or ARDROX 3961 may be used on site after installation of the treated galvanized metal object and sprayed at points or locations on the object that may scratched, nicked, or scored.

The following examples further illustrate embodiments of the present disclosure, which are not intended limit the scope of the present disclosure.

TABLE I
Process Sequence for Medium Dulling

| | | | Temp | Time | Tank |
|---|---|---|---|---|---|
| Step | Process | Chemicals or solutions | (° C.) | (sec) | Spec |
| 1 | Cleaning | alkali salts, surfactants, and acid | 60 ± 10 | 180-300 | PPH |
| | | accelerator | | | coated |
| 2 | Rinsing | Water | ambient | 45-180 | SS or |
| | | | | | coated |
| | | | | | concrete |
| 3 | Dulling, | zinc phosphate mixture (zinc | 60 ± 10 | 45-720 | PPH |
| | medium | nitrate, zinc dihydrogen phosphate, | | | coated |
| | | magnesium nitrate, phosphoric | | | |
| | | acid, zinc fluoborate, and nickel | | | |
| | | nitrate) and sulfuric acid | | | |
| 4 | Rinsing | Water | ambient | 45-180 | PPH |
| | | | | | coated |
| 5 | Drying | NA | NA | NA | Industrial |
| | | | | | fans |
| 6 | Applying | Commercially available rust proof | NA | NA | sprayer |
| | corrosion | material, e.g., GARDOROL DW | | | |
| | inhibitor | 400, ARDROX 396/1 E 14, or | | | |
| | | both from Chemetall | | | |

TABLE II
Process Sequence for Dark Dulling

| | | | Temp | Time | Tank |
|---|---|---|---|---|---|
| Step | Process | Chemicals or solutions | (° C.) | (sec) | Spec |
| 1 | Cleaning | alkali salts, surfactants, and acid | 60 ± 10 | 180-300 | PPH |
| | | accelerator | | | coated |
| 2 | Rinsing | Water | ambient | 45-180 | SS or |
| | | | | | coated |
| | | | | | concrete |
| 3 | Dulling, | zinc phosphate mixture (zinc | 60 ± 10 | 60-900 | PPH |
| | dark | fluoride, zinc dihydrogen | | | coated |
| | | phosphate, zinc nitrate, phosphoric | | | |
| | | acid, and nickel fluoride) and | | | |
| | | sulfuric acid | | | |
| 4 | Rinsing | Water | ambient | 45-180 | PPH |
| | | | | | coated |
| 5 | Drying | NA | NA | NA | Industrial |
| | | | | | fans |
| 6 | Applying | Commercially available rust proof | NA | NA | sprayer |
| | corrosion | material, e.g., GARDOROL DW | | | |
| | inhibitor | 400, ARDROX 396/1 E 14, or | | | |
| | | both from Chemetall | | | |

TABLE III
Process Sequence for Serial Dulling

| | | | Temp | Time | Tank |
|---|---|---|---|---|---|
| Step | Process | Chemicals or solutions | (° C.) | (sec) | Spec |
| 1 | Cleaning | alkali salts, surfactants, and acid | 60 ± 10 | 180-300 | PPH |
| | | accelerator | | | coated |
| 2 | Rinsing | Water | ambient | 45-180 | SS or |
| | | | | | coated |
| | | | | | concrete |
| 3 | Dulling, | zinc phosphate mixture (zinc | 60 ± 10 | 45-720 | PPH |
| | medium | nitrate, zinc dihydrogen phosphate, | | | coated |
| | | magnesium nitrate, phosphoric | | | |
| | | acid, zinc fluoborate, and nickel | | | |
| | | nitrate) and sulfuric acid | | | |
| 4 | Rinsing | Water | ambient | 45-120 | PPH |
| | | | | | coated |
| 5 | Dulling, | zinc phosphate mixture (zinc | 60 ± 10 | 60-720 | PPH |
| | dark | fluoride, zinc dihydrogen | | | coated |
| | | phosphate, zinc nitrate, phosphoric | | | |
| | | acid, and nickel fluoride) and | | | |
| | | sulfuric acid | | | |
| 6 | Rinsing | Water | ambient | 45-120 | PPH |
| | | | | | coated |
| 7 | Drying | NA | NA | NA | Industrial |
| | | | | | fans |
| 8 | Applying | Commercially available rust proof | NA | NA | sprayer |
| | corrosion | material, e.g., GARDOROL DW | | | |
| | inhibitor | 400, ARDROX 396/1 E 14, or | | | |
| | | both from Chemetall | | | |

TABLE IV
Process Sequence for Medium Dulling

| | | | Temp | Time | Tank |
|---|---|---|---|---|---|
| Step | Process | Chemicals or solutions | (° C.) | (sec) | Spec |
| 1 | Cleaning | GARDOBOND Additive H7250 | 60 ± 10 | 180-300 | PPH |
| | | with optional H7401 | | | coated |
| 2 | Rinsing | Water | ambient | 45-180 | SS or |
| | | | | | coated |
| | | | | | concrete |
| 3 | Dulling, | GARDOBOND Z 3100 A with | 60 ± 10 | 45-720 | PPH |
| | medium | sulfuric acid blended to working | | | coated |
| | | level and replenish with | | | |
| | | GARDOBOND Z 3100 E and | | | |
| | | sulfuric acid | | | |
| 4 | Rinsing | Water | ambient | 45-180 | PPH |
| | | | | | coated |
| 5 | Drying | NA | NA | NA | Industrial |
| | | | | | fans |
| 6 | Applying | Commercially available rust proof | NA | NA | sprayer |
| | corrosion | material, e.g., GARDOROL DW | | | |
| | inhibitor | 400, ARDROX 396/1 E 14, or | | | |
| | | both from Chemetall | | | |

TABLE V
Process Sequence for Dark Dulling

| | | | Temp | Time | Tank |
|---|---|---|---|---|---|
| Step | Process | Chemicals or solutions | (° C.) | (sec) | Spec |
| 1 | Cleaning | GARDOBOND Additive H7250 | 60 ± 10 | 180-300 | PPH |
| | | with optional H7401 | | | coated |
| 2 | Rinsing | Water | ambient | 45-180 | SS or |
| | | | | | coated |
| | | | | | concrete |
| 3 | Dulling, | Chemetall CrysCoat ZS400 and | 60 ± 10 | 60-720 | PPH |
| | dark | sulfuric acid | | | coated |
| 4 | Rinsing | Water | ambient | 45-180 | PPH |
| | | | | | coated |
| 5 | Drying | NA | NA | NA | Industrial |
| | | | | | fans |
| 6 | Applying | Commercially available rust proof | NA | NA | sprayer |
| | corrosion | material, e.g., GARDOROL DW | | | |
| | inhibitor | 400, ARDROX 396/1 E 14, or | | | |
| | | both from Chemetall | | | |

Although limited embodiments of the dulling processes and products and components produced using the dulling processes have been specifically described and illustrated herein, many modifications and variations will be apparent to those skilled in the art. Accordingly, it is to be understood that the dulling processes and products and components produced using those processes according to principles of the disclosed devices, systems, and methods may be embodied other than as specifically described herein. The disclosure is also defined in the following claims.

What is claimed is:

1. A process for dulling a galvanized metal object comprising the steps:
obtaining a non-passivated galvanized metal object in at least two attachable sections including a first section and a second section;
cleaning the galvanized metal object in a first bath comprising alkali salts, surfactants, water and an acidic accelerator;
rinsing the galvanized metal object in a water bath;
soaking the galvanized metal object in a dulling bath comprising zinc phosphate and acid for at least 120 seconds to produce a treated galvanized metal object; and
measuring the treated galvanized metal object with a spectrophotometer to obtain a value and wherein the value is 56 or less.

2. The process of claim 1, wherein the galvanized metal object is soaked for at least 5 minutes.

3. The process of claim 1, wherein the dulling bath comprises a mixture comprising zinc nitrate, zinc dihydrogen phosphate, magnesium nitrate, phosphoric acid, zinc fluoborate, and nickel nitrate.

4. The process of claim 1, wherein the dulling bath comprises a mixture comprising zinc fluoride, zinc dihydrogen phosphate, zinc nitrate, phosphoric acid, and nickel fluoride.

5. The process of claim 1, wherein the treated galvanized metal object is a component of a transmission tower or a distribution tower.

6. The process of claim 1, wherein the first section and the second section are attached to one another after the soaking step.

7. The process of claim 1, wherein the treated galvanized metal object is re-soaked in the dulling bath for at least 60 additional seconds.

8. The process of claim 1, wherein the treated galvanized metal object is treated with a corrosion inhibitor after removal from the dulling bath.

9. The process of claim 1, wherein the non-passivated galvanized metal object is a nut, a bolt, an art work, a metal chain link fence, a guard rail, a temporary road sign, a street sign, a freeway sign, or combinations thereof.

10. A tower for carrying electrical conductors comprising:
an upstanding body having at least one support arm extending laterally of the body;
said body and said at least one support arm being galvanized with a zinc-based material;
said body and said at least one support arm being dulled and having a spectrophotometer reading of 56 or less produced by a dulling process comprising:
cleaning the body and the at least one support arm in a first bath comprising alkali salts, surfactants, water and an acidic accelerator; and
soaking the body and the at least one support arm in a dulling bath comprising zinc phosphate and acid for about 120 seconds to about 720 seconds.

11. The tower of claim 10, wherein the body is a lattice structure.

12. The tower of claim 10, wherein the body is a hollow metal pole.

13. The tower of claim 10, wherein the at least one support arm is bolted to the body.

14. The tower of claim 10, further comprising bolting a second support arm above the at least one support arm.

15. The tower of claim 10, wherein the reading is less than 45.

16. The tower of claim 12, wherein the at least one support arm is bolted to the hollow metal pole.

17. A method of blending a metal structure to the environment comprising:
obtaining a galvanized metal object;
cleaning the galvanized metal object in a first bath comprising alkali salts, surfactants, water and an acidic accelerator;
soaking the galvanized metal object in a dulling bath comprising zinc phosphate and acid for at least 120 seconds to produce a treated galvanized metal object; and
installing the treated galvanized metal object in an exposed environment; and
wherein the treated galvanized metal object has a spectrophotometer value of 56 or less.

18. The method of claim 17, wherein the treated galvanized metal object is a transmission tower or a distribution tower carrying a plurality of conductors.

19. The method of claim 17 wherein treated galvanized metal object is soaked in the dulling bath a second time.

20. The method of claim 17, further comprising the step of applying a corrosion inhibitor to the treated galvanized metal object.
